(19) United States
(12) Patent Application Publication
(10) Pub. No.: US 2007/0286386 A1
(43) Pub. Date: Dec. 13, 2007

(54) Courteous phone usage system

(76) Inventors: Jeffrey Denenberg, Trumbull, CT (US); Anand Katragadda, Bridgeport, CT (US)

Correspondence Address: OUR PAL ASIJA;ASIJA HOUSE, 7 WOONSOCKET AVENUE, SHELTON, CT, 06484-5536, US

(21) Appl. No.: 11/586,279

(22) Filed: Oct. 26, 2006

Related U.S. Application Data
(60) Provisional application No. 60/740,191, filed on Nov. 28, 2005.

(51) Int. Cl. H04M 3/42

(52) U.S. Cl. 379/202.01

(57) ABSTRACT

The Courteous Phone Usage System (CPUS) includes devices and methods and system for assisting cellular phone users to conduct cell phone conversations in a low speech level and with minimal annoyance to other individuals in the immediate vicinity, while providing a certain level of privacy for the cell phone user. The cell phone provides audio, visual, tactile or a combination thereof feedback to the cell phone user when his speech is above a certain threshold. The cell phone user may then take a cue from the feedback and accordingly modify his speech level in real-time.

### RELATED DOCUMENT

This application is based on provisional application by the same title Ser. No. 60/740,191 filed on Nov. 28, 2005 by coinventor Anand Katragadda and the applicants hereby claim priority therefrom.

### BACKGROUND

This invention comprises methods, devices, apparatus and system for courteous phone usage. The present invention allows individual(s) to have courteous phone conversations, which are not perceived to be loud and annoying by individuals in the vicinity of the phone user. In addition, this invention also allows the phone user to, in effect, keep his conversation as private as possible.

### THE PROBLEM

Prior art methods and apparatus for courteous phone usage are typically cumbersome, expensive and inconvenient, in the sense that for example the phone user has no real feedback from the phone device to inform the individual that they are speaking louder than required for the remote party to hear them. In this case the only way the phone user realizes that he/she is loud is by being pointed out by the individuals around them.

In order to attempt to assist individuals in phone usage, historically sidetone has been used in phones. Wherein the user hears the volume of his own speech go up or down in the earpiece thus giving the user the perception of how loud he/she is. Yet another method of promoting CPU is via announcements and signage in the hope that individuals will police themselves.

The courteous phone usage (CPU) system of this invention is designed to allow individuals to get a feedback on the level of their speech so that they can police themselves to alter their behavior. Problems with prior art courteous phone usage systems can be summarized as follows.

Sidetones do not provide an effective way for users to get a distinct indication on how loud they are speaking into the phone. Sidetones can actually make a user speak even louder, since the user perceives that he/she needs to speak louder if he/she is in an environment with background noise.

Physical attachments to the phone mouth piece although can be effective, they are not practical.

Speaking loudly into phones when in close proximity of other individuals is discourteous and has a tendency to annoy people around the phone user.

Most modern phones compensate for the user's low speech volume. This in effect moots any reason for individuals to speak loudly into the cell phone.

Speaking louder than required, can lead to a poor quality of audio transmission.

Certain electronic means of reducing the level of speech heard by surrounding individuals (e.g. active noise cancellation) is expensive and does not give the user the required feedback.

The phenomenon of individuals speaking louder than required is to a large degree psychological.

### SUMMARY

This invention comprises methods, devices, apparatus and system for courteous phone usage. The present invention assists users to be courteous users of phones. When the phone detects that the user's speech is above a predetermined level, the phone gives an audio, tactile or visual indication in real-time. The user can then use this indication to continue his/her conversation at a lower speech level. The CPUS has overcome the problem of individuals being discourteous users of phones.

Courteous use of phones leads to more tolerance of phones while amidst people and will allow individuals to use their phones where they have had to move away (if they could) or to wait for the time when they would have some privacy space. Furthermore, CPUS assists individuals in the correct usage of a phone wherein one need not speak at a high volume for the remote party to hear, as most modern phones will amplify a user's low speech volume. The network can be a hybrid network of landlines, cellular networks, cellular towers and the INTERNET. Phone can be any combination of cell phones, POTS phones and computer phones and feedback can be audio, visual or tactile. The network may inhibit phone calls from phones lacking CPUS feature.

### PRIOR ART

A prior art search was neither commissioned nor conducted. However the applicant is intimately familiar with the prior art. The inventors are aware that even in POTS (Plain Old Telephone Service) sidetones are employed wherein audio feedback of speaker's own voice is locally added to the earpiece for clarity and aesthetic feel of communication, but the purpose in the present invention is quite different from such sidetones. In POTS there was no dynamic gain adjustment for speech volume requiring some method to control average speech level.

In this method, it is expected that the phone user will gain clues (the clue being in effect him hearing his own speech via the phone's earpiece) from the sidetone and in turn will adjust his level of speech. In applicants' method, establishments like restaurants, transportation hubs, and etc. post explicit signs requesting courteous phone usage. In this method there is an absolute ban on phone usage and designated areas akin to phone booths are provided.

In this method special physical attachments are used on the mouthpiece of the phone to limit audio radiating into the immediate vicinity and technologies like active noise cancellation are used in an attempt to reduce the audio radiation in the vicinity of the phone user.

At any rate none of the prior art methods and systems known to the applicants and or their attorney disclose the EXACT embodiment of this inventor that constitutes a simple, elegant, quick, convenient, informative, language independent, location independent affordable means of facilitating courteous phone usage.

### OBJECTIVES & FEATURES

The objects of the invention have been omitted in view of the implication in Gentry v Berkline 124 F.3d 1473 (Federal Circuit, 1998) However the entire invention is characterized by its simplicity, elegance of design, ease of manufacture, service and use and even aesthetics as will become apparent from the following brief description of the drawings and the detailed description of the best mode preferred embodiment. The following is a list of some of the features in at least one embodiment.
a) Enjoyable, entertaining and intellectually engaging experience.
b) Non-intrusive to the mobile phone user or people in the vicinity.
c) User Friendly, intuitive and easy to install & operate.
d) Aesthetically appealing, modular and durable
e) Cost effective as it requires no additional training
f) No modification or enhancement required to the mobile phones for some embodiments.
g) Suitable for people of all ages and gender in all types of situations.
h) The CPUS can be customized based on a number of parameters i.e. time, date, location, background noise levels, level of user acceptable feedback, location of the mobile phone and mobile phone specific preferences
i) The network can be a hybrid network of landlines, cellular towers and the INTERNET. Phone can be any combination of cell phones, POTS phones and computer phones and feedback can be audio, visual or tactile.
j) The network may inhibit phone calls from phones lacking CPUS feature.

### BRIEF DESCRIPTION OF THE DRAWINGS

These objects and features of the invention shall now be described in relationship to the following drawings.

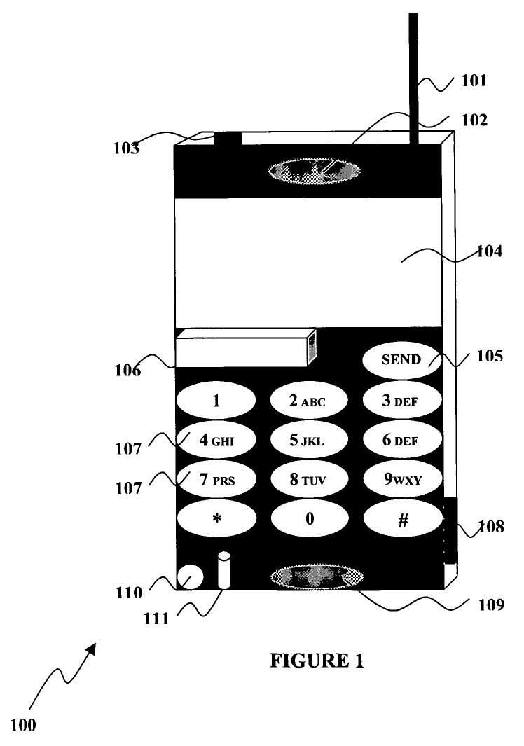

a) FIG. 1 is a schematic diagram of a typical cell phone unit.

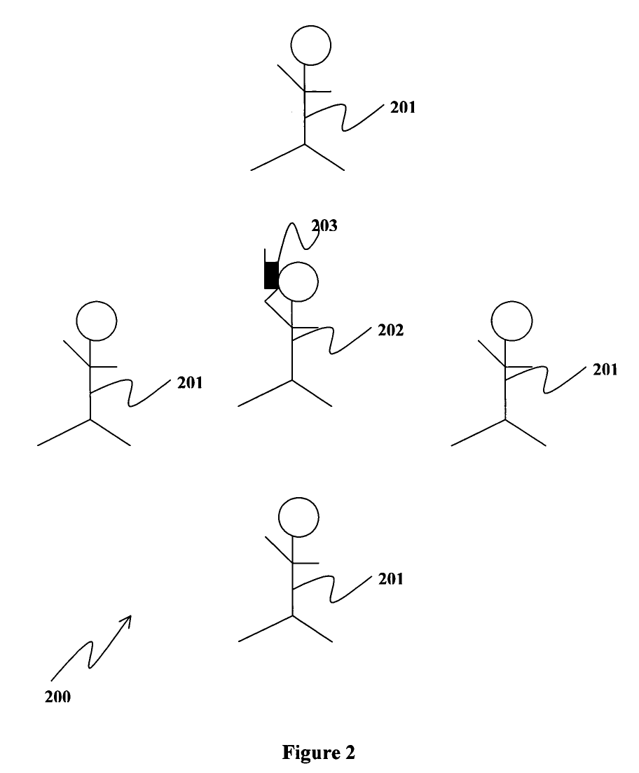

b) FIG. 2 is a schematic depicting a general cell phone user in a room setting.

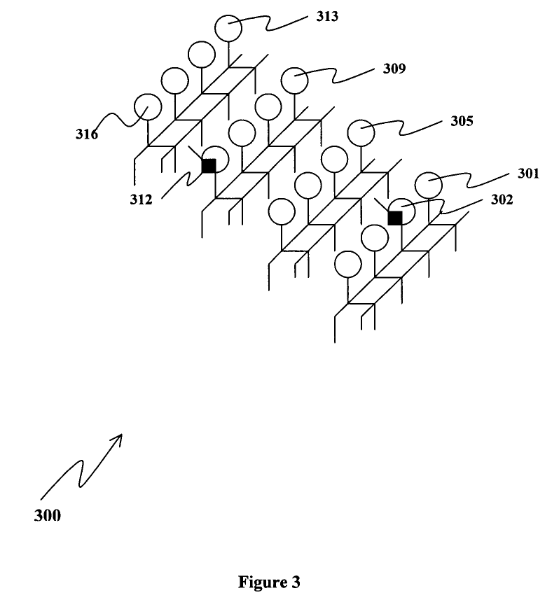

c) FIG. 3 is a schematic depicting cell phone users in a transportation setting e.g. in a train.

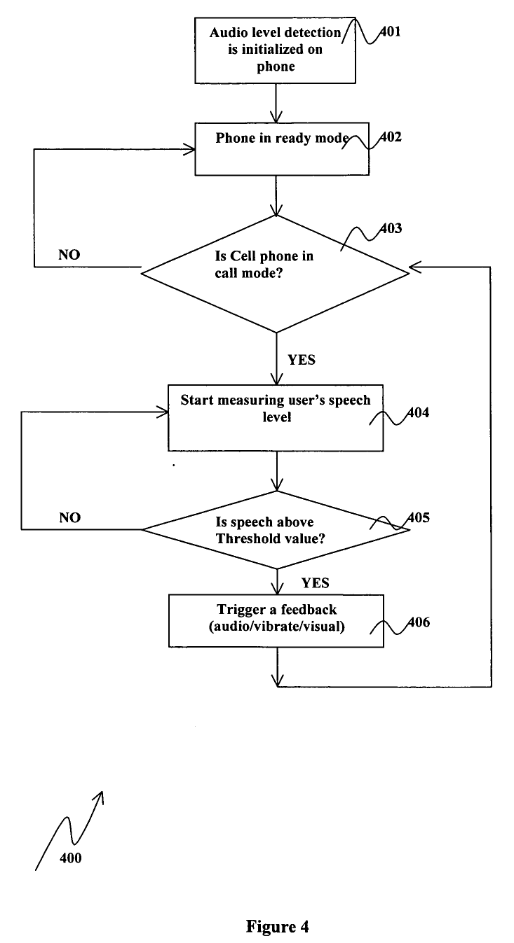

d) FIG. 4 shows a schematic flow chart of the CPUS operation.

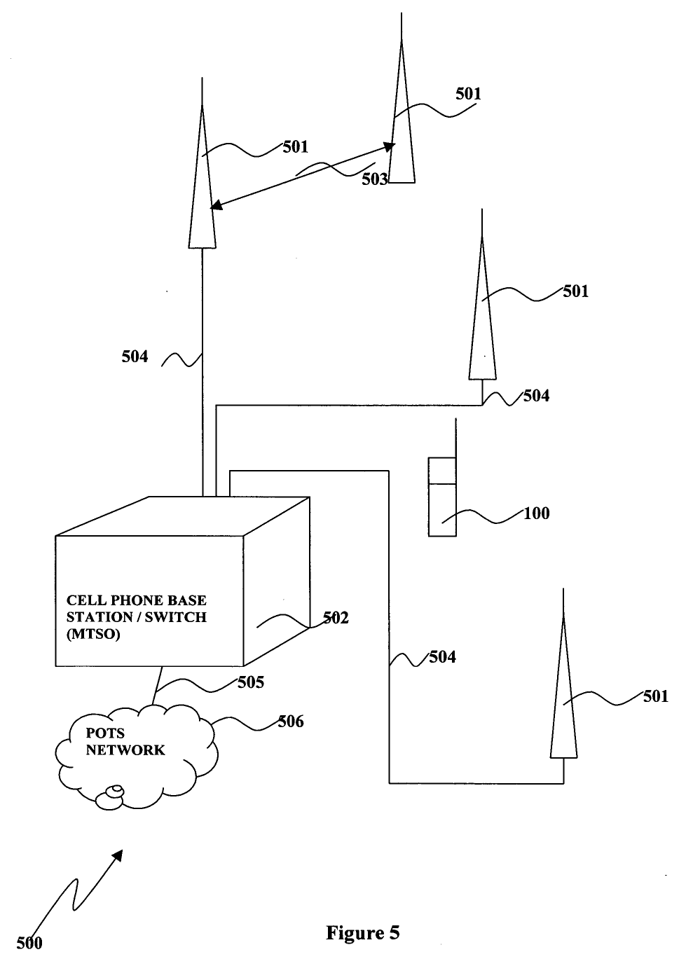

e) FIG. 5 shows a schematic diagram of a typical cell phone network.

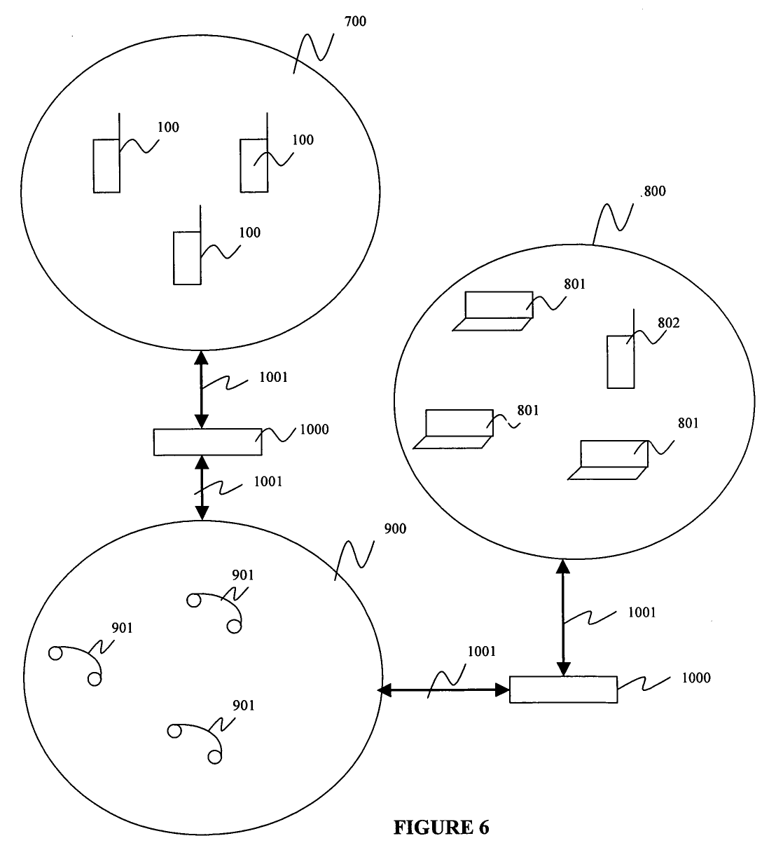

f) FIG. 6 shows a schematic diagram of cell phone network, POTS and the Internet and various components generally.

### DETAILED DESCRIPTION OF THE BEST MODE PREFERRED EMBODIMENT

As shown in the drawings wherein like numerals represent like parts throughout the several views, there is generally disclosed in FIG. 1 is a schematic of a typical cell phone as relates to the CPUS complete with an antenna 101, speaker 102, power switch 103, LCD display 104 which serves to display call information, text, graphic and video content, onhook/offhook/Send multipurpose button 105, processing engine 106 keyboard keys 107, internal rechargeable battery 108, microphone 109, indicator LED 110, and an internal vibrator 111.

FIG. 2 shows schematic of a typical scenario wherein the cell phone user 202 is using a cell phone 203 in the vicinity of several individuals 201. This figure depicts several individuals 201 typically within a few feet (in the order of between 5 to 15 feet). The distances are such that if the cell phone user 202 speaks in a higher than normal volume, one or more of the individuals 201 will consider it disturbing. This scenario is akin to individuals speaking on a cell phone in a hallway or in a room setting.

FIG. 3 shows schematic of a typical scenario for the CPUS. Schematic shows four rows of four individuals per row (301.316) sitting in a transportation system (e.g. a bus, train etc). There are two cell phone users (302 and 312). The cell phone users are 312 and 302.

FIG. 4 shows a flow chart of the operation process of the CPUS. Process 401 is a step wherein audio level detection program function is initialized on the cell phone. 402 is a step where in the cell phone is in a ready mode. 403 is a decision step wherein the CPU periodically checks if the cell phone is in a call mode. If the answer in step 403 is NO then the phone continues to be in ready mode. If the answer in step 403 is YES, then the system proceeds to step 404. Step 404 starts to measure the cell phone user's speech level in real-time mode. 405 is a step where the system continuously compares the user's speech level to a preset threshold value. If the answer to step 405 is NO, the system continues to monitor the speech level. If the answer to step 405 is YES, the system proceeds to trigger a feedback to the phone user via audio (such as a beep) or tactile (such as vibrating) or visual (such as blinking a light on the phone). The duration and type of feedback are initialized at the start of the CPUS process. After the feedback is complete, the system goes back to step 403.

FIG. 5 shows a schematic diagram of a typical cell phone network complete with cell tower 501, base station MTSO (Mobile Telephone Switching Office 502, communication links 504, communication trunk lines 505 and the POTS (Plain Old Telephone Service) network 506. Typically the cell phone 100 communicates with the closest cell tower 501, the cell tower in turn are connected via communication links 504 and are managed by a cell phone base station 502, also called MTSO (Mobile Telephone Switching Office). As a cell phone moves from the range of one cell tower to another, it is the function of the MTSO to maintain the cell phone connection and communication. The MTSO's will typically have communication trunk lines 505 connecting to the POTS network 506. Cell towers 501 may alternatively also be connected to each other via bidirectional communication links such as 503.

FIG. 6 shows a schematic diagram of cell phone network, POTS and the Internet and various components generally complete with cell phone network 700, the INTERNET 800 and POTS 900 network. Typically these networks are interconnected via gateways 1000 and corresponding trunk links 1001. The Cell phone network 700 comprises of various components such as the cell phones 100, cell towers and associated hardware and software components of a typical cell phone network. The network may be based on a multitude of technologies and support a multitude of protocols. The Internet consists of numerous computers 801 which could be servers, desktop systems, laptops and even special purpose devices such as VoIP phones 802. In order to make voice calls, VoIP software from companies such as Skype, Microsoft, Yahoo, etc. are installed on the computers or on the VoIP phones.

Operation

The use and operation of this system by consultants of average skill in the art is simple and even intuitive, nonetheless the inventor recommends the following steps.
1. The CPUS program is installed into the cell phone's processing engine 106. The program may be written in any of the computer languages e.g. C++, JAVA, assembly etc. The installation can be done via wireless connection to the cell phone device such as bluetooth, infrared, OTA (over the air), or via an USB cable or preloaded into the removable memory chip in the phone.
2. Once the CPUS program is loaded onto the cell phone 100, the cell phone user then configures the program for his own preference e.g. setting the program to launch automatically when the phone is on call or on a manual mode or the user just creates a feature profile.
3. In addition to the configuration in step (2) above, the user may also opt for custom setting such a specific setting for then the user is a passenger in a train 300. In 300 the cell phone user could be 302 or 312. In yet another scenario the cell phone user 202 could be in a room or hallway surrounded by other individuals 201. Thus the threshold value for scenario 300 would be lower than the threshold value for scenario 200, due to the fact that the cell phone user is much closer to individuals in 300 embodiment than in the 200 embodiment.
4. The user can also configure the threshold value for his specific need, for example he might want a very low threshold wherein he wants to speak in a low voice so as to keep his conversation as private as possible in addition to being courteous.
5. The user can choose to activate the CPUS automatically when the cell phone is in a call or the user may elect to activate the CPUS himself on a need basis.
6. Once the CPUS program activates, it starts to continuously measure the signal level of the cell phone users speech coming into the cell phone from the microphone 109.
7. The moment the CPUS program detects that the level of the cell phone users speech is above the threshold, the CPUS program generates a feedback indication (e.g. vibrating the phone, sending a beep or another audio clue to the speaker 102, or it might blink special purpose or existing LEDs on the phone). The purpose of the feedback being to alert the cell phone user that his speech is above a threshold and could be bothersome or discourteous for other users e.g. 201, 301, 303, 306 and so forth. Upon receipt of the feedback from the cell phone, the user can than lower his speech.
8. The CPUS continues to monitor the user's speech throughout his conversation and provides feedback whenever the user's speech level goes above the threshold.
9. Once the cell phone user hangs up the phone, the CPUS goes back into a ready mode and awaits the next time the phone is used again.
10. Cell phone carriers may integrate the CPUS function in their networks.
11. Part or all of the CPUS functionality may be integrated into the cell phone carrier systems.
12. Part or all of the CPUS functionality may be integrated into an add-on device.
13. Part or all of the CPUS functionality may be built on special hardware integrated with the cell phone.
14. Variations of side tones could be used to attempt to provide similar functionality as CPUS.
15. A hybrid system may be developed wherein part of the CPUS is on the carrier network and part is a function of the cell phone.
16. The CPUS can be developed for regular landline based phones.
17. Additional feature may be added to CPUS wherein the user is also given feedback if his/her speech is too low for proper transmission.
18. Another feature may be added wherein the CPUS enabled device informs the appropriate network that it's active and running. This signal could be used by the network to for instance allow communication through from the device.
19. The CPUS may be integrated as a component of a VoIP client software.
20. CPUS configuration of FIG. 5 may be modified, wherein the MTSO 502 or a component of the Cell phone network or the POTS network performs some or all of the steps listed depicted in FIG. 4 except step 406. A substitution of step 406 is where the processing component sends a control signal to the phone to turn on the visual, audio or tactile feedback.
21. Another variation of CPUS of FIG. 5 may be adopted, wherein the MTSO 502 or a component of the Cell phone network or the POTS network performs some or all of the steps listed depicted in FIG. 4 except step 406. A substitution of step 406 is where the processing component injects an audio feedback into the forward audio channel so that the user gets the appropriate cue that he/she is too loud.
22. CPUS configuration of FIG. 6 may be modified, wherein CPUS is implemented as a software application running on computers. CPUS in monitors the microphone audio data in conjunction with a VoIP client software application such as Skype, Yahoo messenger, Microsoft messenger etc. Upon detection of the condition that the user is speaking too loud, CPUS generates the necessary audio feedback and/or visual via the computer display into the speaker/headset being used by the user to avail the use of the VoIP software.
23. The CPUS may be adopted to enable a user to communicate from computer to land line, or cell or other phones.
24. The CPUS may be adopted to enable a user to communicate from computer to land line calls.
25. Another contemplated variation of CPUS by the inventors comprises where in the user uses a VoIP phone 802 to make calls to a computer or cell phone or a POTS phone, such that the CPUS software is executed on the VoIP phone.
26. Another variation of CPUS enables the user to make from computer calls to phone.
27. Another contemplated variation of CPUS comprises, where the gateway 1000 is executes the CPUS program and generates the appropriate audio feedback to be sent back to the specified device. For example the gateway may serve a computer user at or a POTS phone or a cell phone user.
28. Another variation of CPUS enables the user to make calls from computer to phones.
29. CPUS may be integrated into the POTS telephones.
30. In another variation CPUS may be integrated into VoIP phones, which act as a substitute for POTS phones 901 and can reside either in the 900 or 800 network.
31. A variation of CPUS enables communication between a cell phone and a VoIP phone.
32. A user with CPUS enabled phone may provide functionality to the remote party who does not have access to CPUS on his device.
33. In yet another variation contemplated by the CPUS inventors includes a WiMAX enabled device.

The inventor has given a non-limiting description of rapid deployment system of this invention. Due to the simplicity and elegance of the design of this invention designing around it is very difficult if not impossible. Nonetheless many changes may be made to this design without deviating from the spirit of this invention. Examples of such contemplated variations include the following:
a) The shape and size of the cell phone may be modified.
b) The color, aesthetics and materials used for a cell phone may be enhanced or varied.
c) Indicator may be integrated into the cell phone LCD display.
d) Additional complimentary and complementary functions and features may be added to the cell phone.
e) A more economical version of the system and method may be adapted.
f) A more upscale version of the device may be adapted.
g) Other feedback variations may be used.
h) A different method of measuring user speech level might be implemented.
i) An additional special purpose microphone may be employed.
j) Cell phone carriers may integrate the CPUS function in their networks.
k) Part or all of the CPUS functionality may be integrated into the cell phone carrier systems.
l) Part or all of the CPUS functionality may be integrated into an add-on device.
m) Part or all of the CPUS functionality may be built on special hardware integrated with the cell phone.
n) Variations of sidetones could be used to attempt to provide similar functionality as CPUS.
o) A hybrid system could be developed wherein part of the CPUS is on the carrier network and part is a function of the cell phone.
p) A variation of the CPUS can be developed for regular landline based phones.
q) A variation of the CPUS can be developed, wherein the user is also given feedback if his/her speech is too low for proper transmission.

Other changes such as aesthetics and substitution of newer materials as they become available, which substantially perform the same function in substantially the same manner with substantially the same result without deviating from the spirit of the invention may be made.

Following is a listing of the components used in the best mode preferred embodiment and the alternate embodiments for use with OEM as well as retrofit markets. For the ready reference of the reader the reference numerals have been arranged in ascending numerical order.
100=A cell phone block and schematic diagram generally
101=Cell phone antenna
102=Speaker
103=Power Switch
104=Cell phone LCD display (for status, text, image and video)
105=Send, on hook, off hook button
106=processing engine
107=Keyboard keys
108=Internal rechargeable Battery
109=Microphone
110=Indicator LED
111=Internal vibrator
200=A cell phone user in a room setup schematic diagram generally
201=Individual in the vicinity of a cell phone user
202=Cell phone user
203=Cell phone
300=Cross section of cell phone users in a vehicle (e.g. a Train) generally
301=Row 1 individual 1
302=Row 1 individual using cell phone
303=Row 1 individual 3
304=Row 1 individual 4
305=Row 2 individual 1
306=Row 2 individual 2
307=Row 2 individual 3
308=Row 2 individual 4
309 Row 3 individual 1
310=Row 3 individual 2
311=Row 3 individual 3
312=Row 3 individual using cell phone
313=Row 4 individual 1
314=Row 4 individual 2
315=Row 4 individual 3
316=Row 4 individual 4
400=The CPUS user operation process flow generally
401=Audio level detection program initialization
402=Cell phone in ready and waiting mode.
403=Decision step for checking if cell in call mode
404=Process step measuring of speech level initiated
405=Decision step to check if speech level is above threshold
406=Step to trigger the feedback. (Audio, tactile or visual)
500=Cell phone network generally with connectivity to POTS
501=Cell tower/antenna systems
502=Cell base station/MTSO
503=Inter antenna link (radio or land line)
504=Communication link
505=Trunk line(s)
506=The POTS network
600=Cell, POTS and Internet networks and various components
700=Cell phone network cloud
800=The Internet network cloud
801=Computer (desktop/laptop/server)
802=VoIP phone
900=The POTS network cloud
901=POTS handset
1000=Gateway
1001=Communication link
   Definitions and Acronyms

A great care has been taken to use words with their conventional dictionary definitions. Following definitions are included here for clarification.

Amplify=Increasing the level of a signal.

Antenna=Electronic component, which facilitates the transmission and reception of radio waves.

Assembly=To put together in a prescribed manner.

Audio level detection program=A software program which measures the level (amplitude) of sound/speech.

Audio transmission=The conversion and transmission of sound via means of electromagnetic waves.

Background=Immediate surrounding area.

Battery=Source of electrical power.

Bi-directional communication links=Wireless or wired two way connections

Bluetooth=A wireless communication protocol and system.

C++=A computer programming language.

Call mode=A cell phone in an active call.

Cell phone=A transportable phone, also known as mobile phone.

Cell phone base station=A cell phone network component which manages cell sites

Cell phone carrier=A cell phone service provider company.

Cell phone company=A company which provides cell phone service.

Cell phone network=Systems and communication links used by cell phone Companies.

Cell provider interface=Computer or humans facilitating data exchange.

Cell tower=Cell phone antenna, associated radio and electronics

Cell user interface=The interface which enables interaction between cell phones and humans.

Cellular phone=Portable phone, also known as mobile phone.

Communication links=Wireless or wired communication connections.

Computer=An electronic device used for storage and processing of information.

Computer language=A method for writing computer instructions.

Connection charge=Charge levied by cell phone companies.

Courteous=Gracious, nice.

CPU=Courteous phone usage.

CPUS=Courteous phone usage system.

Database=A digital repository of information.

Discourteous=No courtesy, rude.

Earpiece=A device which converts electromagnetic waves in sound waves.

EDI=Electronic Data Interchange.

EMAIL=Electronic Mail.

Feedback=The process in which part of the output of a system is returned to the input in order to regulate it's further output.

Gateway=A device with connects to dissimilar networks

Hardware=Electronic components such as chips, discreet components.

Hybrid=A mixture of two systems.

Incourteous=Opposite of courteous.

Infrared=A part of the electromagnetic spectrum.

Internal Vibrator=A mechanical motor which when turned on functions to generate vibration.

INTERNET=An interconnected system of networks which connects computers and other devices primarily via the TCP/IP protocol.

Intrusive=Encroaching on privacy.

JAVA=A computer programming language.

Land line=A physical wire which connects a phone to central switching office.

LCD=Liquid Crystal Display.

LEDS=Light emitting diodes.

Microphone=An electronic component which converts sound into electrical signals.

Microsoft messenger=A VoIP client provided by the Microsoft company

Mobile cell phone companies=Any company which provides any part of cell phone service.

Mobile phone=A transportable phone, also known as cell phone.

Mouthpiece=Part of an electronic device which houses the microphone.

OEM=Original equipment manufacturer.

OFFHOOK=Event wherein a phone is ready to dial a number, in the process of dialing or in the process of a connected call.

On Call=Event wherein a phone is connected to a remote phone and a conversation is taking place.

ONHOOK=Event wherein a phone is ready to receive a call.

OTA=Over The Air, a method for cell phones for communication with the cell phone network.

Parameters=A set of rules or preferences.

Perception=Recognition and interpretation of sensory stimuli based chiefly on memory.

POTS=Plain Old Telephone System

POTS network=The POTS with all its associated components

POTS telephone=The telephone device used to connect to the POTS for voice calls.

Power switch=Electronic component which can turn OFF or ON the source of electricity.

Processing engine=The subsystem of a cell phone which could consist of the central processing unit, digital signal processor, memory and other associated components.

Real-time=Instantaneous or fast enough to modify the outcome or behavior of the user.

Removable memory=A computer memory chip which can be removed by the end user.

Ringer=A transducer which emits sound waves in response to electrical signals.

SEND BUTTON=A multifunction button on cell phone, typically used for functions such as onhook, offhook, dial etc.

Side tone=The sound of the speaker's own voice as heard in the speaker's telephone receiver.

Skype=A company which provide the Skype VoIP client software to make and receive phone calls to phones and computers. Skype enabled phones are devices which can connect directly to a data network to make and receive phone calls.

Speaker=Device which converts electrical signals into Sound.

Speaker=User of the cell phone.

Tactile=A sensation of touch.

Threshold=The boundary or level of acceptable sound amplitude.

TOUCH TONES=Tones generated by pushing keys on a phone keypad.

Trigger=The act which set in motion some course of events such as turning on the internal vibrator.

Trunk line=A direct communication channel between two entities.

USB=Universal Serial Bus.

VoIP=Voice over Internet Protocol. The technology used to transmit voice conversations over a data network using the Internet Protocol

VoIP Phone=A telephone device which primarily connects to a data network for facilitating telephone calls.

Volume=Level of audio.

Wireless=Via Radio waves.

WIRELESS LINKS=Radio wave based communication links

Yahoo messenger=A VoIP client provided by the yahoo internet services co.

The reader can now readily see how the above detailed description results in the following benefits of the invention over the prior art.
a) The CPUS provides an engaging, interactive, useful and entertaining experience to the cell phone user.
b) The CPUS provides the cell phone user a method of receiving real-time feedback on the level of his/her speech.
c) The CPUS has over come the problem of loud cell phone users.
d) The CPUS provides the cell phone user valuable incentives to be a courteous phone user.
e) The CPUS provides the cell phone user an option to select the type and level of feedback required in different scenarios.
f) The user is not charged a per minute cost for using the CPUS.
g) The CPUS can deliver an audio, visual or tactile feedback to the user.
h) The CPUS increases the tolerance for people around the cell phone user.
i) The CPUS can be used by an unlimited number of cell phone users.
j) The CPUS allows cell phone uses to keep their conversation private.
k) The CPUS allows users to use their phone in places where phone usage is not permitted for fear of discourteous phone users.
l) Cell phone users can interact with the CPUS based on their self-defined parameters.
m) The CPUS provides cell phone carriers with additional source of revenue due to increased cell phone usage.
n) The CPUS allows multiple cell phone users in close proximity.
o) The CPUS can work with any current and future cell phones.
p) The CPUS requires no modification to cell phones to operate in some modes.
q) The CPUS is conducive to cell phone usage and is language independent.
r) CPUS operation is user friendly and intuitive and CPUS does not require additional user training.
s) CPUS is easy to setup and operate and is suitable for people of all ages.
t) CPUS is suitable for use with a variety of background noises.
u) The CPUS can be customized based on a number of parameters i.e. time, date, location, background noise levels, level of user acceptable feedback, location of the mobile phone and mobile phone specific preferences
v) The network can be a hybrid network landlines, cellular towers and the INTERNET. Phone can be any combination of cell phones, POTS phones and computer phones and feedback can be audio, visual or tactile.
w) The network can inhibit phone calls from phones lacking CPUS feature.

While this invention has been described with reference to illustrative embodiments, this description is not intended to be construed in a limiting sense. Various modifications and combinations of the illustrative embodiments as well as other embodiments of the invention will be apparent to a person of average skill in the art upon reference to this description. It is therefore contemplated that the appended claim(s) cover any such modifications, embodiments as fall within it's true scope.

The inventors claim:

1. A courteous phone usage system comprising:
a) a telephone network;
b) a plurality of phones interfaced to said network;
c) a means for monitoring the amplitude of a user's voice connected to at least one of said plurality of phones; and
d) sending a signal to the user when said amplitude of user's voice exceeds a pre-determined threshold.

2. The courteous phone usage system of claim 1 wherein at least one said plurality of phones is selected from a group consisting of cellular mobile phones, POTS phones, and VOIP computer Internet phones.

3. The courteous phone usage system of claim 1 wherein
(i) said network is a hybrid network of the Internet and POTS; and
(ii) said signal to said user comprises audio.

4. The courteous phone usage system of claim 1 wherein said signal to said user includes visual.

5. The courteous phone usage system of claim 1 wherein said signal to said user comprises tactile feedback.

6. The courteous phone usage system of claim 1 wherein:
a) said network is a hybrid network of cellular phone network, Internet and POTS;
b) at least one cellular phone is connected to said hybrid network; and
c) said means for monitoring the amplitude of said user's voice is done by said cellular phone network, further said hybrid network includes means to disallow a phone call without CPUS feature.

7. The courteous phone usage system of claim 1 wherein said predetermined threshold is an adjustable user programmable parameter.

8. The courteous phone usage system of claim 1 wherein said predetermined threshold is automatically adjusted as a function of ambient noise.

9. A process of courteous phone usage comprising the steps of:
a) loading and initializing of the audio level detection program on the phone;
b) powering on said cell phone until READY mode is indicated;
c) monitoring said cell phone until a call mode is indicated;
d) measuring of user's speech level while cell phone is in said call mode;
e) comparing in real time user's speech level to a pre set threshold level;
f) triggering of audio feedback on said cell phone if said speech level exceeds said threshold level;
g) providing an indication to said user;
h) returning to monitoring mode once said speech level falls below said preset threshold; and
i) returning to said monitoring mode once said cell phone call is over.

10. The process of courteous phone usage of claim 9 wherein said indication to said user of said phone is audio and where in said phone is selected from the group consisting of cell phones, POTS phones and computer Internet phones.

11. The process of courteous phone usage of claim 9 wherein said feedback to said user of said phone is from a feedback group consisting of audio, visual and tactile feedback,

12. The process of courteous phone usage of claim 9 wherein said network is the INTERNET and said phone call is carried as VoIP (Voice Over Internet Protocol.

13. The process of courteous phone usage of claim 9 wherein said threshold values are user configurable.

14. The process of courteous phone usage of claim 9 wherein said threshold values are automatic.

15. The process of courteous phone usage of claim 14 wherein said automatic threshold values are function of ambient noise around said user of said cell phone.

16. The process of courteous phone usage of claim 9 wherein said threshold values and triggering of feedback is automatic.

17. A process of courteous cell phone usage comprising plurality of phones connected to a network comprising the steps of:
a) initiating a phone call from a phone of said plurality of phones;
b) automatically initializing and activating a preinstalled courteous phone usage program;
c) monitoring the speech level of said phone call;
d) sending feedback to said user as long as said user's speech amplitude exceeds a preset threshold level in said pre-installed courteous phone usage program;
e) acknowledgement by said user of said feedback;
f) lowering and maintaining of said speech amplitude of said user of said cell phone below said preset threshold during the entire duration of said cell phone call;
g) terminating said call until next use; and
h) placing CPUS program in wait mode until next call.

18. The process of courteous phone usage of claim 17 wherein:
a) said feedback to said user of said phone is from a feedback group consisting of audio, visual and tactile feedback;
b) said phone call sends its status signal to the network; and
c) said network can inhibit said phone call as a function of said status signal.

19. The process of courteous phone usage of claim 17 wherein said phone is a from group consisting of cell phones, POTS phones and Internet computer phones.

20. The process of courteous phone usage of claim 17 wherein said network is INTERNET and said phone call is carried as Voice Over Internet Protocol.
